(19) United States
(12) Patent Application Publication
(10) Pub. No.: US 2007/0272609 A1
(43) Pub. Date: Nov. 29, 2007

(54) Reuse of waste materials via manure additive

(75) Inventors: Rominder P.S. Suri, Audubon, PA (US); Surya Deepthi Kalyanam, Devon, PA (US); Uthappa Devaiah Mandepanda, Wayne, PA (US)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(73) Assignee: Villanova University

(21) Appl. No.: 11/438,920

(22) Filed: May 23, 2006

(51) Int. Cl. C02F 3/00

(52) U.S. Cl. 210/603

(57) ABSTRACT

A composition for treating waste materials such as, for example, livestock manure and mushroom compost. The composition includes: (1) gypsum obtained either as commercial product or as waste wallboard; (2) lime; (3) silica or fly ash; (4) optionally water; (5) optionally iron slag; and (6) optionally portland cement. Further provided is a method of stabilizing waste materials which includes the step of treating the waste materials with the composition. Still further provided are a method of measuring the amount of ammonia in a waste material, a method of measuring the amount of hydrogen sulfide in a waste material, or both.

### TECHNICAL FIELD

The present invention relates generally to waste materials and, more particularly, to a manure additive facilitating the method of reusing manure. Even more particularly, one focus of the present invention is to stabilize livestock manure in order to decrease, or possibly eliminate, foul odor and to reduce the leaching of phosphorus and nitrogen into ground and surface waters.

### BACKGROUND OF THE INVENTION

As the human population continues to increase, so does the quantity of livestock (pork, poultry, and beef animals) required to satisfy the dietary demands of consumers. The livestock industry has experienced an exponential growth in the last few decades. Along with the huge production of livestock, necessary to meet the demand, comes the manure which is a byproduct of the livestock industry: enormous amounts of animal manure are produced.

Generally, livestock manure is considered waste. Manure is used, however, both as fertilizer in agricultural fields and as a fuel to be burned for energy. Not all livestock farms use the same techniques for manure disposal. Some farms store manure in open fields until the manure is transported to the agricultural fields. Such storage leads to ground-water contamination, creates odor problems, and risks the growth of disease-causing bacteria. In terms of an increasingly problematic odor, the spectrum ranges from poultry to hog to cow manure. Thus, the process of handling and managing the manure in a hygienic, inoffensive, and inexpensive manner has become a top priority for agricultural livestock establishments and one of the major problems facing the livestock industry today.

In the past, manure was mixed with plant bedding and spread on agricultural land every few days. Problems arise in high population density areas, however, where multiple farms are clustered together and the land base is small. More recently, on larger farms, farmers use little or no plant bedding; rather, they store the manure as slurry in tanks, pits, or lagoons. Although these methods of managing livestock waste are effective, their use is hampered by high costs, minimal reduction in odor, and environmental risks of nutrient leaching into surface waters.

Livestock waste consists of a wide range of nutrients, including phosphorous, nitrogen, and trace elements, and has enriched humus materials which will improve soil structure, thereby increasing aeration, water intake, and stability of soil aggregates. But manure has a high solubility in water, raising the possibility of water pollution. The decomposition of the organic components of livestock waste into nitrogen and phosphorous compounds causes problems. Specifically, an increase in phosphorous and nitrogen compounds in bodies of water (i.e., lakes, rivers, and reservoirs) that receive surface waters results in algae growth, deoxygenation and the blackening of water, unpleasant odors, an increase of water-born organisms, death of aquatic life, and formation of scum on water surfaces.

As an alternative to direct land disposal, it is common practice to compost the animal waste. Composting, the biological stabilization of organic wastes, is a process during which the waste is separated into solids and liquids. This is a time-consuming effort, however, requiring around 45 to 60 days for stabilization without the benefit of overall reduction of odor. Furthermore, land application remains ultimately the way to dispose of the liquid.

Obnoxious odors from animal manure can be a serious nuisance to people who reside close to livestock farms. Also, the production of considerable amounts of gases (e.g., carbon dioxide, ammonia, hydrogen sulfide, methane, carbon monoxide) by the anaerobic decomposition process of manure can be hazardous to both man and livestock. Over 168 chemical compounds have been identified in the air within swine confinement buildings. Some of the main odorous compounds are ammonia, amines, sulfur-containing compounds, volatile fatty acids, indoles, skatole, phenols, alcohols, and carbonyls. Ammonia and hydrogen sulfide are the two constituent compounds in the odorous air from livestock production facilities that are most often measured and reported because they are produced in easily detectable quantities.

Ammonia is highly soluble in water and can be explosive at higher concentrations. It has a sharp, pungent odor and acts as an irritant to moist tissues at relatively low concentrations. It is released from fresh manure and during the process of anaerobic decomposition. Because of its high water solubility, ammonia can be more easily controlled in liquid systems than in solid systems.

Of all the manure gases, hydrogen sulfide is the most toxic and is potentially the most dangerous. It is also soluble in water so that it can be somewhat controlled by high dilution rates. The gas smells of rotten eggs. It is flammable and can be explosive in an oxygen mixture. Hydrogen sulfide is produced during the anaerobic decomposition of manure. High concentrations can be released by agitation and pumping of liquid wastes.

Various techniques have been tried to control the sources of odors in the manure of livestock operations. These odor-control techniques include: (1) converting some volatile compounds to a less volatile form by pH control or by chemical conversion or biological conversion to a less odorous or less volatile compound; (2) inhibiting the anaerobic decomposition of manure; and (3) physically confining the odor sources. Covered manure storage tanks and anaerobic manure treatment devices may be effective in controlling the escape of odorants.

In recent years, manure odors have been the subject of intense research around the world. Widespread attention has been put on adding odor-control chemicals to manure storage tanks or animal feeding areas. Materials have been proposed to prevent the release of odorous compounds, inhibit their formation, or mask their odor.

Enzymes and other digestive aids have also been proposed for controlling livestock production odors. Unfortunately, product secrecy prevents manufacturers from disclosing the composition of these agents, which makes these products hard to evaluate. In most cases these products do not significantly reduce manure odors and most of these agents are expensive.

Disinfecting additives attempt to inhibit microbial mediated processes occurring in livestock manure. These additives include: chlorine, orthodichlorobenzene, and hydrogen cyanamide. Although there is some reduction of malodor from livestock manure with disinfectants, the reduction in emissions is usually short-term and such chemicals are toxic.

Oxidizing agents (such as potassium permanganate, hydrogen peroxide, and ozone) have been found to significantly suppress the release of odorous gases. These agents are effective in reducing malodors, however, for only a short period of time. This limitation is primarily due to the high volumes of organic matter in livestock wastes that require large quantities of oxidizing agents for complete oxidation. Thus, this method is limited to short-term reduction of odor emissions, and is expensive to maintain.

In view of the shortcomings of the known approaches, there is an apparent need for an improved way to manage livestock manure. It is therefore an object of the present invention to provide a method and composition useful to stabilize livestock manure, mushroom compost, and other waste materials. An additional object is to stabilize manure using a combination of recycled materials, yielding an environmentally favorable method. A related object is to eliminate or at least decrease the foul odor inherent in manure. Another object is to reduce the tendency of contaminating elements such as phosphorus and nitrogen to leach out of manure. Still another object is to provide livestock farmers with an effective, economically viable, and efficient method for odor control and manure stabilization. It is another object of the present invention to decrease transportation costs while allowing manure to retain its helpful properties. Yet another object is to provide a composition that, in combination with other commercially available fertilizers in the industry, creates a medium to dispose more easily of waste material such as manure.

Additional objects and advantages of this invention will be apparent from the following detailed description.

### BRIEF SUMMARY OF THE INVENTION

To achieve these and other objects, and in view of its purposes, the present invention provides a composition for treating waste materials such as, for example, livestock manure and mushroom compost. The composition includes: (1) gypsum obtained either as commercial product or as waste wallboard; (2) lime; (3) silica or fly ash; (4) optionally water; (5) optionally iron slag; and (6) optionally portland cement. Further provided is a method of stabilizing waste materials which includes the step of treating the waste materials with the composition. Still further provided are a method of measuring the amount of ammonia in a waste material, a method of measuring the amount of hydrogen sulfide in a waste material, or both.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 illustrates the apparatus used to measure the amount of ammonia in fresh and stabilized manures according to one embodiment of the present invention;

FIG. 2 illustrates the apparatus used to measure the amount of hydrogen sulfide in fresh and stabilized manures according to another embodiment the present invention;

FIG. 3 is a graph reflecting the absorption of ammonia from a fresh sample of poultry manure, i.e., a sample not treated with any additive;

FIG. 4 is a graph reflecting the absorption of ammonia from a sample (Sample No. 31) of poultry manure both with and without a specific additive of a first composition;

FIG. 5 is a graph reflecting the absorption of hydrogen sulfide from a sample (Sample No. 31) of poultry manure both with and without the same specific additive reflected in FIG. 4;

FIG. 6 is a graph reflecting the absorption of ammonia from a sample (Sample No. 32) of poultry manure both with and without a specific additive of a second composition;

FIG. 7 is a graph reflecting the absorption of hydrogen sulfide from a sample (Sample No. 32) of poultry manure both with and without the same specific additive reflected in FIG. 6;

FIG. 8 is a graph reflecting the absorption of ammonia from a sample (Sample No. 30) of cow manure both with and without a specific additive of a third composition;

FIG. 9 is a graph reflecting the absorption of hydrogen sulfide from a sample (Sample No. 30) of cow manure both with and without the same specific additive reflected in FIG. 8;

FIG. 10 is a graph reflecting the absorption of ammonia from a sample (Sample No. 31) of cow manure both with and without the same specific additive reflected in FIGS. 4 and 5 according to the present invention;

FIG. 11 is a graph reflecting the absorption of hydrogen sulfide from a sample (Sample No. 31) of cow manure both with and without the same specific additive reflected in FIG. 10;

FIG. 12 is a graph reflecting the absorption of ammonia from a sample (Sample No. 32) of cow manure both with and without the same specific additive reflected in FIGS. 6 and 7; and

FIG. 13 is a graph reflecting the absorption of hydrogen sulfide from a sample (Sample No. 32) of cow manure both with and without the same specific additive reflected in FIG. 12.

### DETAILED DESCRIPTION OF THE INVENTION

The materials that combine to form the stabilizing manure additive according to the present invention are chosen on the bases, among others, of their binding properties, availability, and economy. These materials do not alter any of the major useful characteristics of the manure. Each material is used to address one or more of the specific problems and drawbacks inherent in conventional manure additives.

In a first embodiment, the present invention is directed to a composition that can be added to bio-solids (including without limitation, livestock manure), mushroom compost, and other waste materials to give the waste materials useful characteristics. An important parameter of the composition is the proportion of ingredients included in the composition. Preferably, the composition includes: (1) gypsum obtained either as commercial product or as waste wallboard; (2) lime (CaO); (3) silica or fly ash; (4) optionally water; (5) optionally iron slag; and (6) optionally portland cement. Still more preferably, the composition includes gypsum in a weight ratio of about 15-40%, lime in a weight ratio of about 9-40%, silica or fly ash in a weight ratio of about 15-40%, optionally water in a weight ratio of about 0-40%, optionally iron slag in a weight ratio of about 20-25%, and optionally portland cement in a weight ratio of about 30-50%. When portland cement is included in the additive for manure applications, the manure is no longer suitable as fertilizer because it becomes a hard, rock-like product; the rock-like characteristic of the product is useful, however, for disposal purposes or for use in the construction industry.

Gypsum is hydrated calcium sulfate or CaSO₄-2(H₂O). Gypsum is one of the more common minerals in sedimentary environments. It is a major rock-forming mineral that produces massive beds, usually from precipitation out of highly saline waters. Because it forms easily from saline water, gypsum can have many inclusions of other minerals and even trapped bubbles of air and water. Gypsum has a very low thermal conductivity, prompting its use in drywall or wall board as an insulating filler.

Wall board gypsum is commonly used to cover the interior walls of homes, offices, and other structures. It is composed of gypsum and a paper backing that makes up approximately 2-4% of the total wallboard weight. Other uses for gypsum include plaster, some cements, paint filler, and ornamental stone. Gypsum is also used in agriculture as a fertilizer and as a soil amendment. Gypsum is not a liming material and will not increase soil pH.

Limestone is rock that is composed of calcium carbonate (CaCO₃), magnesium carbonate (MgCO₃), and small amounts of other minerals. Lime is made by heating limestone (calcium carbonate) to high temperatures. This process, known as calcining, results in quicklime, or calcium oxide. As used in the context of the present invention, the term “lime” refers to calcium oxide (CaO).

Industrial sand and gravel, often called “silica,” “silica sand,” and “quartz sand,” includes sands and gravels with high silicon dioxide (SiO₂) content. These sands are used in glassmaking; for foundry, abrasive, and hydraulic fracturing applications; and for many other industrial uses. The specifications for each use vary, but silica resources for most uses are abundant. In almost all cases, silica mining uses open pit or dredging mining methods with standard mining equipment. Except for temporarily disturbing the immediate area while mining operations are active, sand and gravel mining usually has limited environmental impact.

Fly ash is a fine, glass-like powder recovered from gases created by coal-fired electric power generation. Thus, fly ash is a coal combustion product and is considered a difficult solid waste. U.S. power plants produce millions of tons of fly ash annually, which is usually dumped in landfills. The compositions of fly ash are highly variable, and commonly consist of oxides of Si, Al, Fe, and Ca, and of the elements Na, P, K, and S. Fly ash is an inexpensive replacement for portland cement used in concrete, while it actually improves strength, segregation, and ease of pumping of the concrete. Fly ash is also used as an ingredient in brick, block, paving, and structural fills. Weathered fly ash, after equilibrating with atmospheric CO₂, is called lagoon ash, which has an alkaline pH and provides a good fixing agent to suppress the availability of heavy metals in manure compost.

Iron is typically manufactured by putting iron sand and charcoal together in a furnace, heating it, and reducing the iron sand. At this point, the impurities contained in the iron sand are melted at high temperature and drained out as slag. In iron manufacturing, about half of the iron sand will be reduced and turned into iron through smelting. The remainder will react at a high temperature (1,200° C. or higher) with the clay in the furnace walls to create a fused silicate mass and melt out into iron slag. Chemical analysis of the iron slag reveals it to be composed of SiO₂ (silicate), Al₂O₃ (alumina), FeO, Fe₂O₃ (oxided iron), and TiO₂ (titanium dioxide).

ASTM C 150 defines portland cement as “hydraulic cement (cement that not only hardens by reacting with water but also forms a water-resistant product) produced by pulverizing clinkers consisting essentially of hydraulic calcium silicates, usually containing one or more of the forms of calcium sulfate as an inter ground addition.” Clinkers are nodules (diameters of 0.2-1.0 inch or 5-25 mm) of a sintered material that is produced when a raw mixture of predetermined composition is heated to high temperature. The phase compositions in portland cement are denoted by ASTM as tricalcium silicate (Ca₃S), dicalcium silicate (Ca₂S), tricalcium aluminate (Ca₃Al), and tetracalcium aluminoferrite (Ca₄AlF). The low cost and widespread availability of the limestone, shales, and other naturally occurring materials make portland cement one of the lowest-cost materials widely used over the last century throughout the world.

The useful characteristics of the manure achieved via addition of the composition according to the present invention are many. First, the manure is stabilized (i.e., the odor emanating from the treated manure is minimized or eliminated). The manure odor decreases to such a significant extent that the treated manure approaches an odorless material. Second, the additive changes the texture of the manure composition so that it can be formed into pellets or coarse powder, which facilitates bagging, storage, transportation, sale, and application. The pellets can be crushed.

The combination of gypsum, silica or fly ash, and lime in certain proportions, perhaps in combination with certain other optional ingredients according to the present invention, has not been previously used for manure stabilization. Known materials that are used as manure additives fail to stabilize the manure; are relatively expensive; do not prevent nutrient leaching into surface water; and do not reduce the burden on land fills. The method and composition of the present invention achieve all of these advantages left unfulfilled by conventional manure additives.

More specifically, the method and composition of the present invention offer several advantages. At least two of the materials used to form the manure additive are discarded materials, inexpensive, and readily available. Fly ash is a discarded material. Gypsum can be obtained from waste wallboard otherwise discarded. Thus, reuse or recycling of discarded materials is achieved—an environmentally favorable result. Two source materials each having negative characteristics, untreated manure and discarded materials, are combined to produce an excellent fertilizer.

Manure has nutrients such as phosphorous and nitrogen. Government regulations define how much manure can be applied as fertilizer per specified area because phosphorous and nitrogen leach out of the manure and can contaminate water reservoirs. In addition, phosphorous and nitrogen foster algae growth and can cause pollution, which is a major problem, for example, in Chesapeake Bay watersheds. The phosphorous in the manure does not leach, once the manure is treated with the additive of the present invention, from the manure into surface water resources when the manure is stored outside or spread on agricultural fields. As discussed in more detail below, the method and composition of the present invention reduce phosphorous leaching by about 87%. Similar results are expected for the nitrogen in the manure.

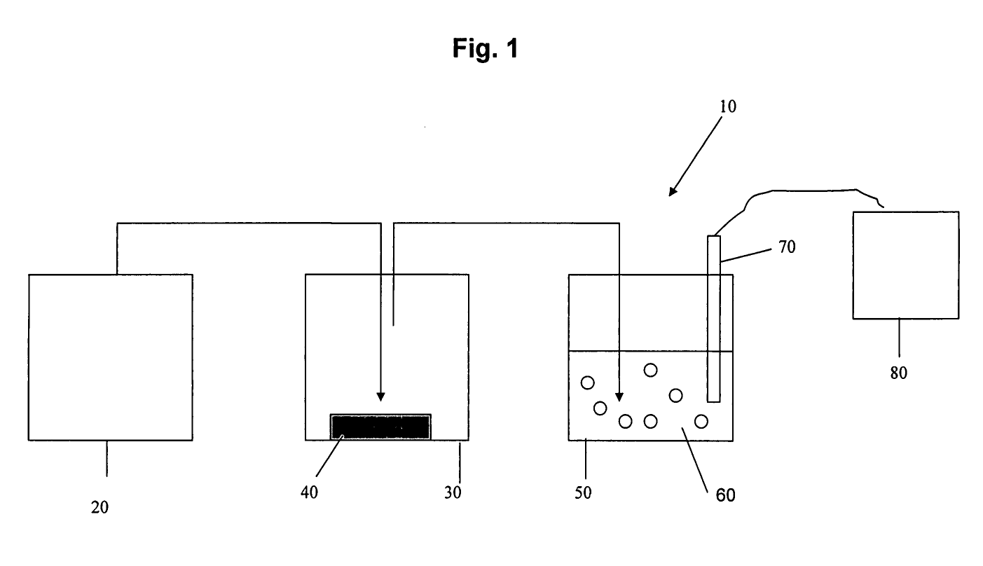

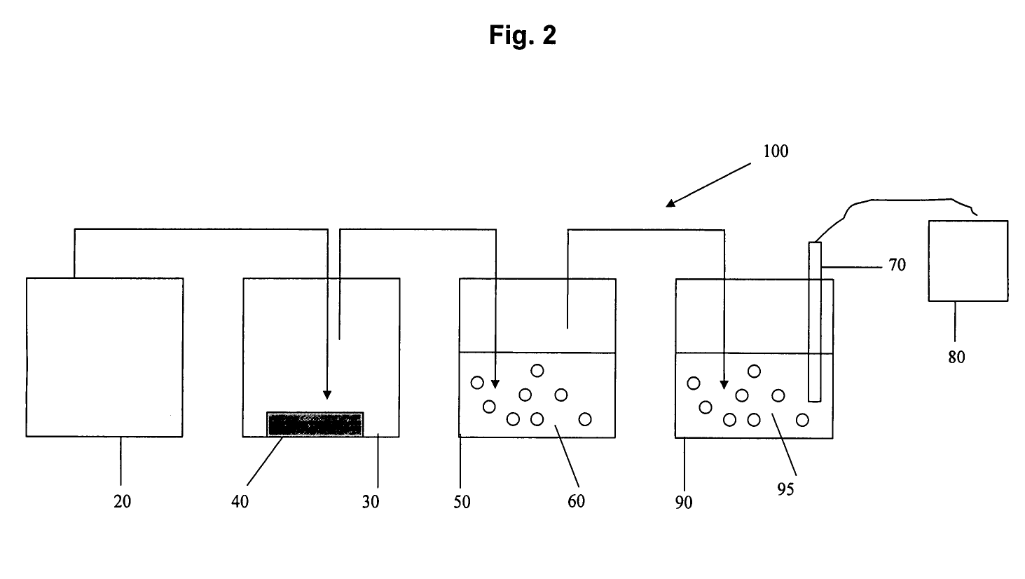

Another embodiment of the present invention is the development of an analytical method for odor detection. Several components of odors are relevant to research: (1) odor quality, measured by comparing the odor with a known odor; (2) odor strength, measured by the amount of fresh air needed to dilute the odorous air to the threshold odor level; and (3) odor occurrence, measured by the frequency and total length of time the odor persists. There are two general approaches to measuring odor: (1) measure the concentration of specific gases in an air sample, and (2) use the human nose to perceive odor. The embodiments of the present invention illustrated in FIGS. 1 and 2 incorporate the first of these two methods.

The main odor-causing compounds in manure are ammonia and hydrogen sulfide, which are generated by the decomposition of manure. The wastes are in an anaerobic state when excreted and remain anaerobic unless oxygen is introduced into the system. There are two forms of ammonia solution: NH₃, which is a non-ionized gas, and NH₄, which is the ionized form. The relative proportion of each depends upon the pH. Manure normally has a pH of 6.5 to 7.0. Reducing pH in manure with an acid (hydrochloric, sulfuric, phosphoric or nitric) to about 5 increases nitrogen fixation thus reducing ammonia emissions. Unfortunately, addition of some of these acids increases the nitrogen or phosphorous content of the manure, and can increase the release of hydrogen sulfide. At a pH of 4 to 5, amino acid decarboxylation occurs, leading to the release of odorous amines and sulfur compounds.

Virtually all of the ammonia in animal waste has the potential to be lost as NH₃ gas. In addition to being an odor problem, ammonia gas release is increasingly being considered an environmental problem, because it tends to be oxidized by various oxidants in the air to produce nitrous oxides, which are considered major contributors to acid rain.

Hydrogen sulfide (H₂S), which is produced by anaerobic microorganisms that convert sulfate in manures to sulfide, is considered the characteristic odor of livestock urine. It is a highly toxic and malodorous gas that can reach levels that are threatening to livestock and humans. Exposure to a few minutes of hydrogen sulfide concentrations of 2000 ppm has proven fatal to humans. In addition, animals exposed to sub-lethal doses may become more susceptible to pneumonia and respiratory diseases.

At relatively high pH levels, hydrogen sulfide release is minimized, but the release of ammonia and organic acids is enhanced. At a pH of 9.5, almost no hydrogen sulfide will escape the manure. A pH of about 12 allows solids to settle and reduces the moisture content and odor production. The generation of most odor components also is increased at higher temperatures.

The most critical point in controlling odor emissions is regulating the volatilization rate of the ammonia and hydrogen sulfide. Among the factors that influence the volatilization rate are source concentration, surface area, net radiation, air temperature, wind velocity, and relative humidity. The present invention seeks to control the microbial formation of the volatile organic compounds, the best way to successfully control the volatilization rate. The manure additive of the present invention slows down or stops the microbial fermentation of the organic matter in waste before the hydrolytic and acetogenic bacteria become active. Thus, the additive prevents the formation of volatile organic compounds, which represent odor. The use of the additive inhibits the fermentation and, in turn, reduces the odor produced. In addition, nutrients are retained in the manure (although it is desirable to remove H₂S from the manure, the nutrients present in ammonia desirably remain in the manure) and the production of greenhouse gases is inhibited. The additive is environmentally safe, relatively inexpensive, and easy to apply.

In order to evaluate the amount of odor reduction achieved by the additive composition of the invention, a method for measuring the presence of these odor-causing compounds in the manure was achieved. This method can be computerized. The odor is measured by determining the concentrations of the odorous compounds (i.e., ammonia and hydrogen sulfide) present in the manure and the results are compared for the fresh and stabilized (with the additive) manure.

FIG. 1. illustrates the apparatus 10 used to measure the amount (concentration) of ammonia in the fresh and stabilized manures. A source of inert gas 20, such as argon, delivers the inert gas to a closed bottle 30 having the manure sample 40. The gas produced in the closed bottle 30 is transferred to a closed first reactor vessel 50 having an HCl solution 60. Ammonia is basic and is ionized in the HCl solution 60 to the ammonia ion. A pH probe 70 measures the pH of the HCl solution 60 and sends a commensurate signal to a computer 80, which can read and report the pH measurement as well as calculate the concentration of ammonia based on that measurement.

FIG. 2 illustrates the apparatus 100 used to measure the amount (concentration) of hydrogen sulfide in the fresh and stabilized manures. As for the apparatus 10 illustrated in FIG. 1, a source of inert gas 20, such as argon, delivers the inert gas to a closed bottle 30 having the manure sample 40. The gas produced in the closed bottle 30 is transferred to a closed first reactor vessel 50 having an HCl solution 60. The ammonia is removed from the gas in the HCl solution 60. The gas is then delivered to a second reactor vessel 90 having a basic solution 95 (e.g., NaOH). Hydrogen sulfide is acidic and can be stripped in the basic solution 95. A pH probe 70 measures the pH of the basic solution 95 and sends a commensurate signal to a computer 80, which can read and report the pH measurement as well as calculate the concentration of hydrogen sulfide based on that measurement.

The concentrations of the ammonia and hydrogen sulfide gases, in both fresh manure and in manure stabilized using the additive according to the present invention, were measured using the apparatus of FIGS. 1 and 2. After a series of experimental trials, a set of optimized conditions were developed for the odor detection. The optimized conditions for the tests conducted on poultry manure were: (1) weight of manure=1 g; (2) initial pH of HCl=2.3, (3) initial pH of NaOH=9.8; (4) volume of absorbent=20 ml; (5) inert gas flow rate=0.6 L/min; and (6) time of absorption=1 hour or less. The optimized conditions for the tests conducted on cow manure were: (1) weight of the manure=1 g; (2) initial pH of HCl=3.5, (3) initial pH of NaOH=9.5; (4) volume of absorbent=20 ml; (5) inert gas flow rate=1 L/min; and (6) time for bubbling=1 hour or less.

### EXAMPLES

The following examples are included to more clearly demonstrate the overall nature of the invention. These examples are exemplary, not restrictive, of the invention. As the sample numbers indicate, a large number of samples were prepared. A brief summary of some of the stabilized samples, omitting those samples for which test results were not as good, is as follows:

Sample No. 1: Portland cement and manure were mixed in a 1:1 ratio and left for a day. The resultant mixture had some cement which had no water to blend with the manure. The mixture had a moderate strength and could be crushed by hand with significant force.

Sample No. 6: Manure, portland cement, gypsum, CaO, and water were combined in equal ratios and mixed well. The material was formed into a coarse paste. After a day of setting time, a powdery substance with no lumps was formed.

Sample No. 9: Manure, gypsum, and water were combined in equal ratios and mixed well. The material was formed into a paste and, after a day of setting time, formed into a lump which was very easy to break. When crushed, however, the lump compressed and then broke into granulates.

Sample No. 11: Manure, CaO, and water were combined in equal ratios and mixed well. The material was formed into a paste and, after a day of setting time, formed into a very fragile lump. The lump broke easily into powder and had a yellow color.

Sample No. 16: Manure, CaO, and water were combined in the ratio 2:1:2 and mixed well. The material was formed into a paste and, after a day of setting time, turned into a soft lump. When crushed, the lump broke into a powder and had, comparatively, much less smell.

Sample No. 23: Equal ratios of manure, silica (200 mesh and finer), gypsum, CaO, and water were mixed well. The material was formed into a paste, brown in color. After a day of setting time, the mixture had a smooth texture and could be crushed by hand. The smell was reduced.

Sample No. 24: Equal ratios of manure, silica (40 to 100 mesh), gypsum, CaO, and water were mixed well. The material was formed into a paste, brown in color. After a day of setting time, a smooth-textured mixture resulted. The mixture broke easily.

Sample No. 25: Equal ratios of manure, silica (fine granular), gypsum, CaO, and water were mixed well. The material was formed into a paste, brown in color. After a day of setting time, the result was similar to the mixture of Sample No. 24 but the color was light brown when compared and the smell was less.

Sample No. 29: Manure, CaO, gypsum, fly ash, and water were combined in equal ratios and mixed well. After a day of setting time, the mixture was soft and could be easily crushed by hand.

Sample No. 30: Manure, fly ash, gypsum, CaO, and water were combined in the ratio 2:1:1:1:1. The sample was found to be hard, but crushable. The odor was reduced significantly in two days.

Sample No. 31: Manure, fly ash, gypsum, CaO, and water in the ratio 1:1:1:1:2 were combined and mixed well. This sample was hard and crushable. The odor was reduced significantly in a week.

Sample No. 32: Manure, gypsum, fly ash, CaO, and water in the ratio 3:2:3:1:2 were combined. This sample was soft and could be crushed easily into powder. The odor was reduced significantly in a week.

Sample No. 31 for poultry manure was determined to offer the best combination of desirable characteristics of the samples tested. Thus, the test results provided below were obtained using Sample No. 31.

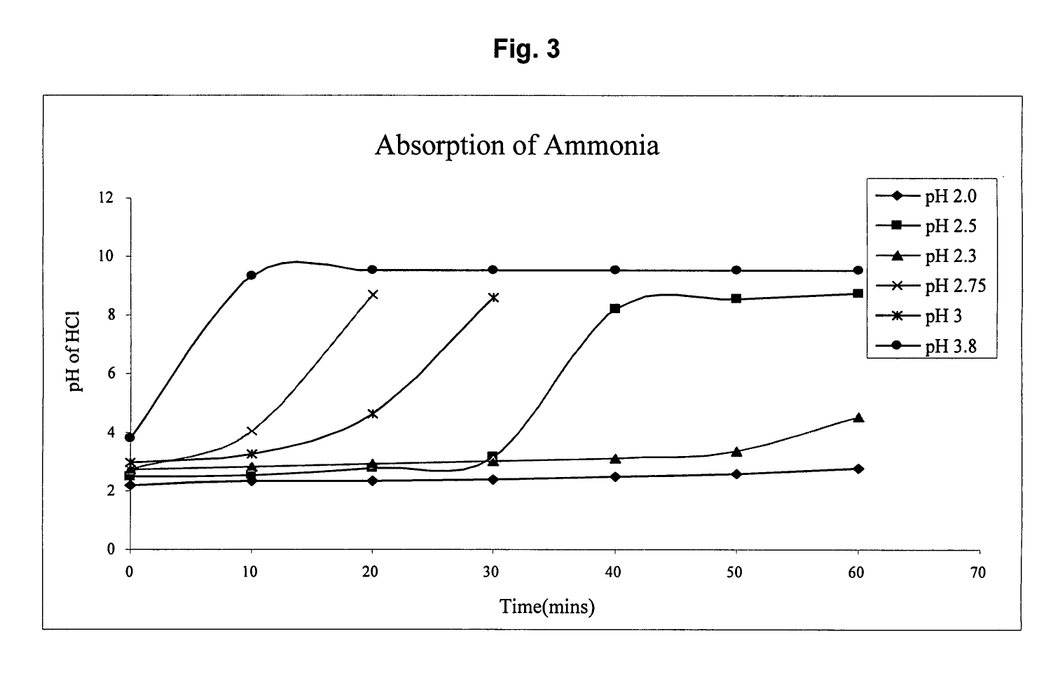

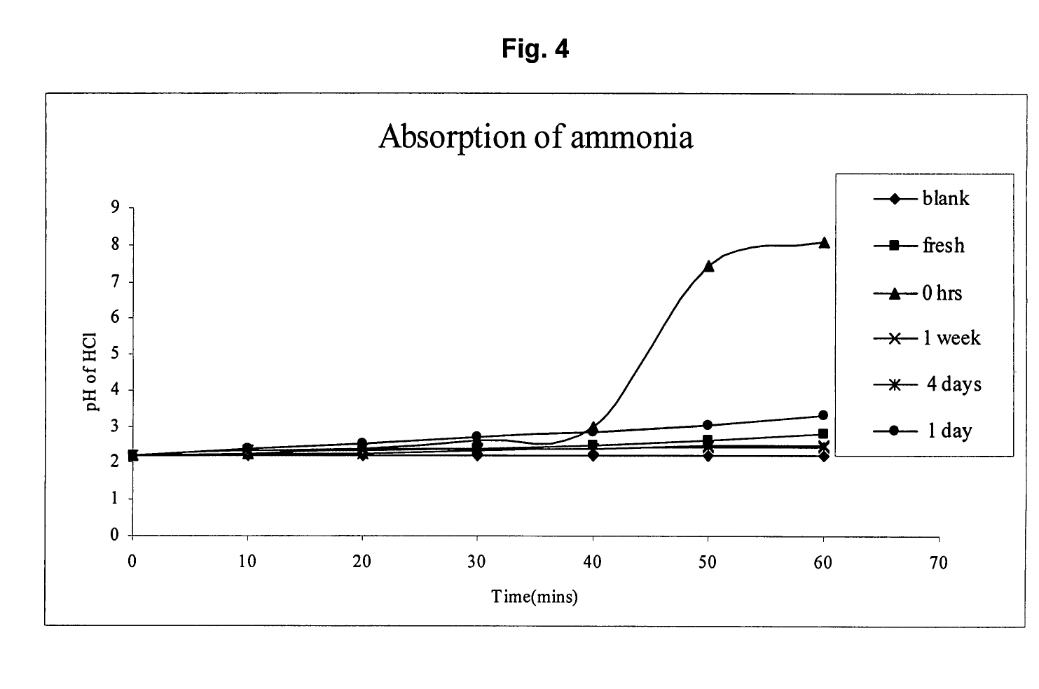

The tests performed to obtain the data reflected on the graphs of FIGS. 3-7 were done under the optimized conditions for poultry manure outlined above. FIG. 3 is a graph reflecting the absorption of ammonia from a fresh sample of poultry manure, i.e., a sample not treated with any additive. FIG. 4 is a graph reflecting the absorption of ammonia from Sample No. 31. The blank (diamond) data provide a baseline without any sample present in the first reactor vessel 50. The data represented by square points reflect measurements taken from fresh manure (i.e., no additive). The four remaining data sets (represented by triangle, cross, star, and circular points, respectively) reflect measurements taken from manure including the additive of Sample No. 31 for certain lengths of time (0 hours, 1 week, 4 days, and 1 day, respectively) before tests were conducted. The data show that, with the inclusion of the additive, the manure sample was relatively stable following an initial release of ammonia.

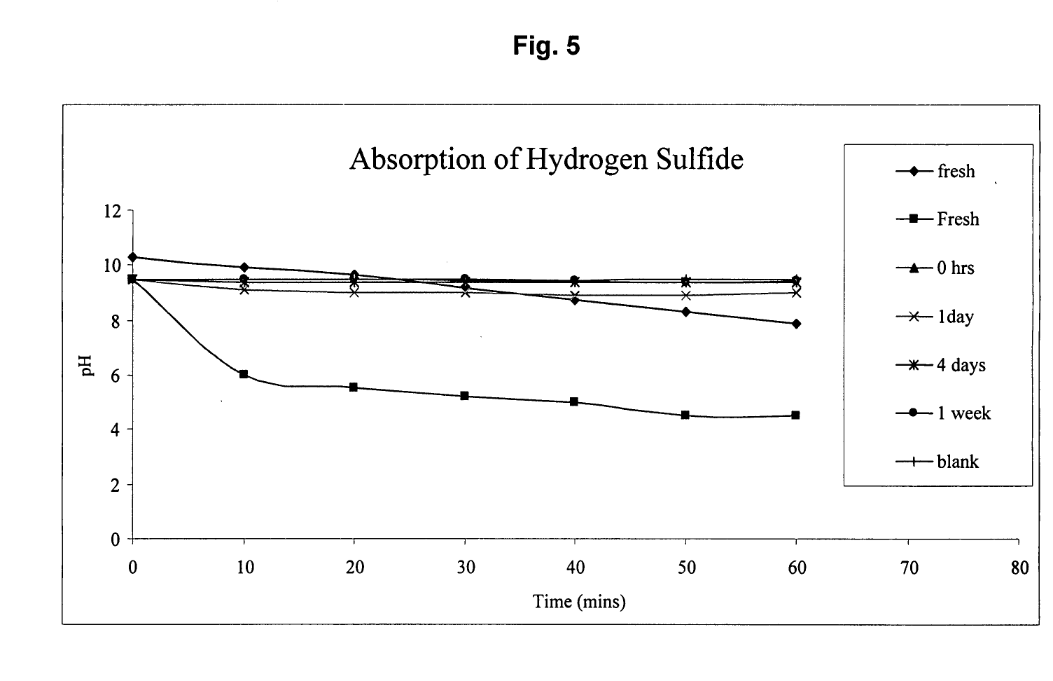

FIG. 5 is a graph reflecting the absorption of hydrogen sulfide from the poultry manure treated with Sample No. 31. Data are included representing two, separate samples of fresh manure at different pH levels (diamond and square points). The diamond points are of no great importance given their different pH relative to the remaining data. The square points show odor emanating from the manure as hydrogen sulfide is removed. The data reflecting tests done on manure incorporating the additive of Sample No. 31 for different times show that the additive almost immediately “ties up” the hydrogen sulfide, thereby reducing odor.

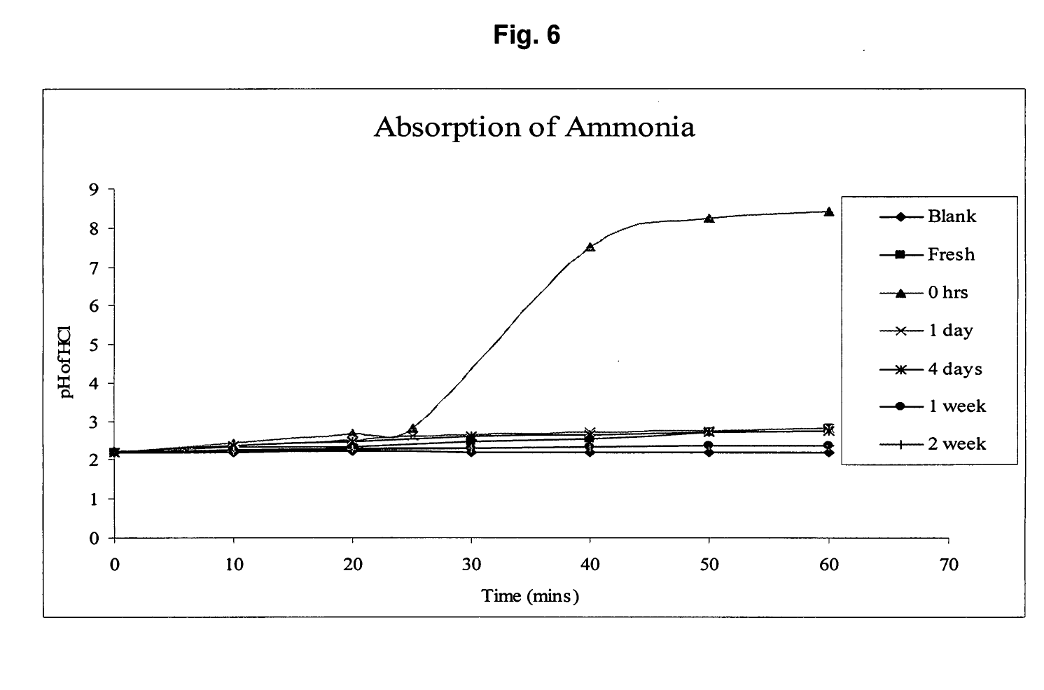

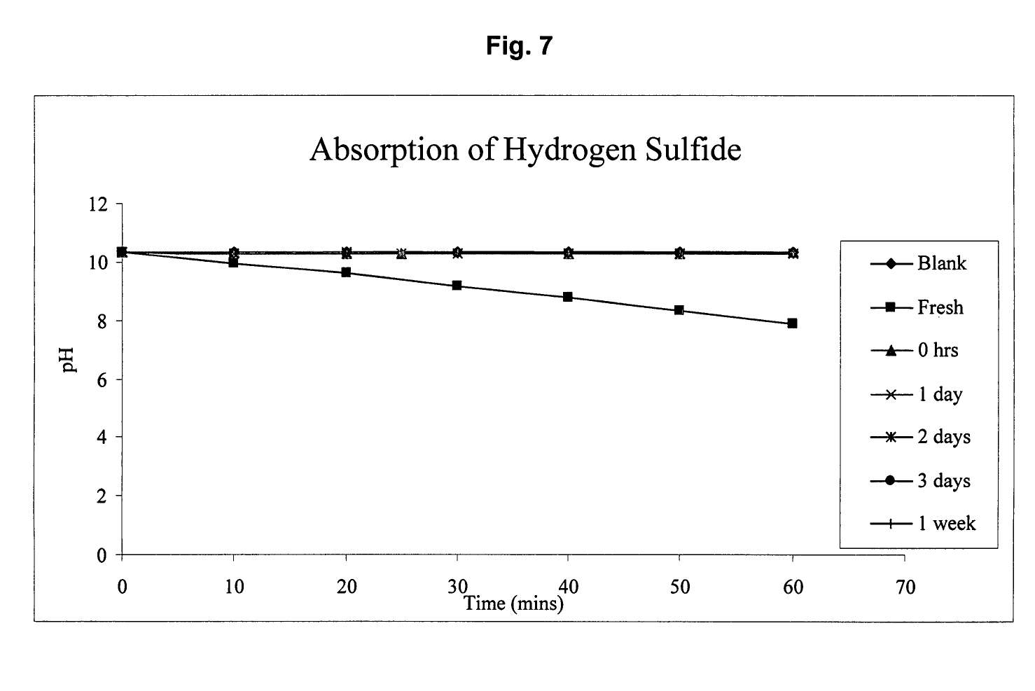

For comparison purposes, FIG. 6 is a graph reflecting the absorption of ammonia from the poultry manure treated with Sample No. 32. FIG. 7 is a graph reflecting the absorption of hydrogen sulfide from the poultry manure treated with Sample No. 32.

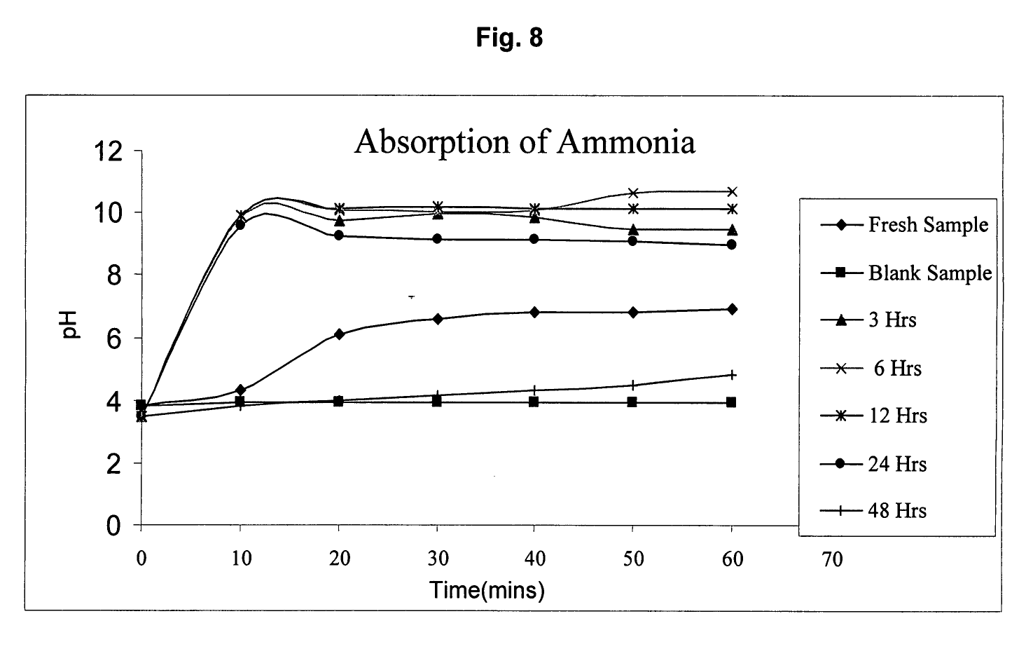

The tests performed to obtain the data reflected on the graphs of FIGS. 8-13 were done under the optimized conditions for cow manure outlined above. FIG. 8 is a graph reflecting the absorption of ammonia from a fresh sample of cow manure (i.e., a sample not treated with any additive) and with the manure treated with the additive of Sample No. 30. The additive took about 2 days before the majority of the ammonia was stabilized.

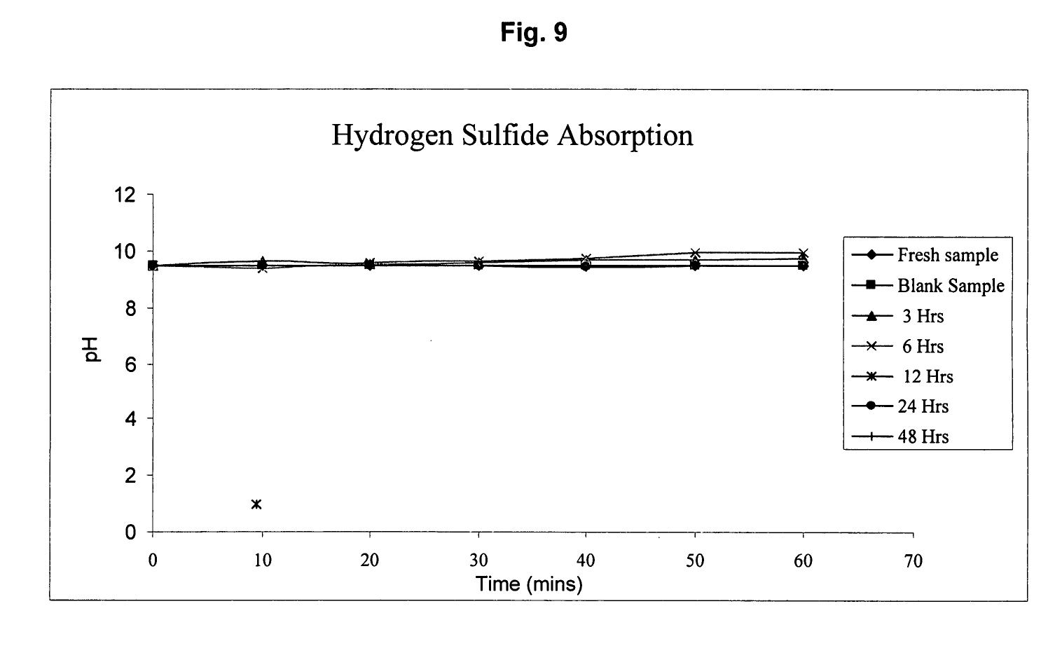

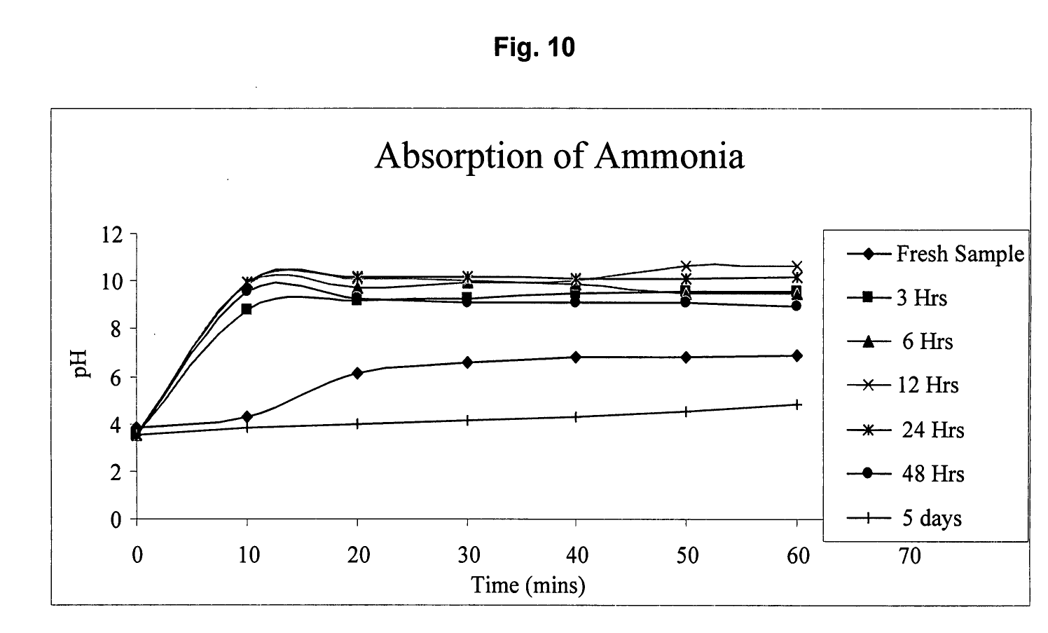

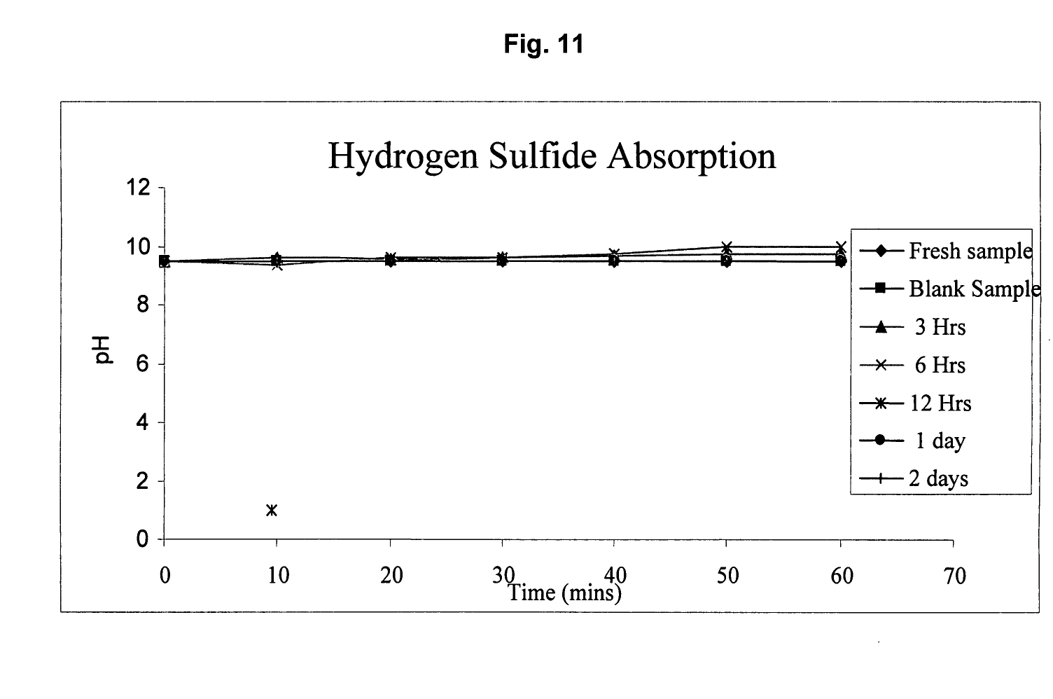

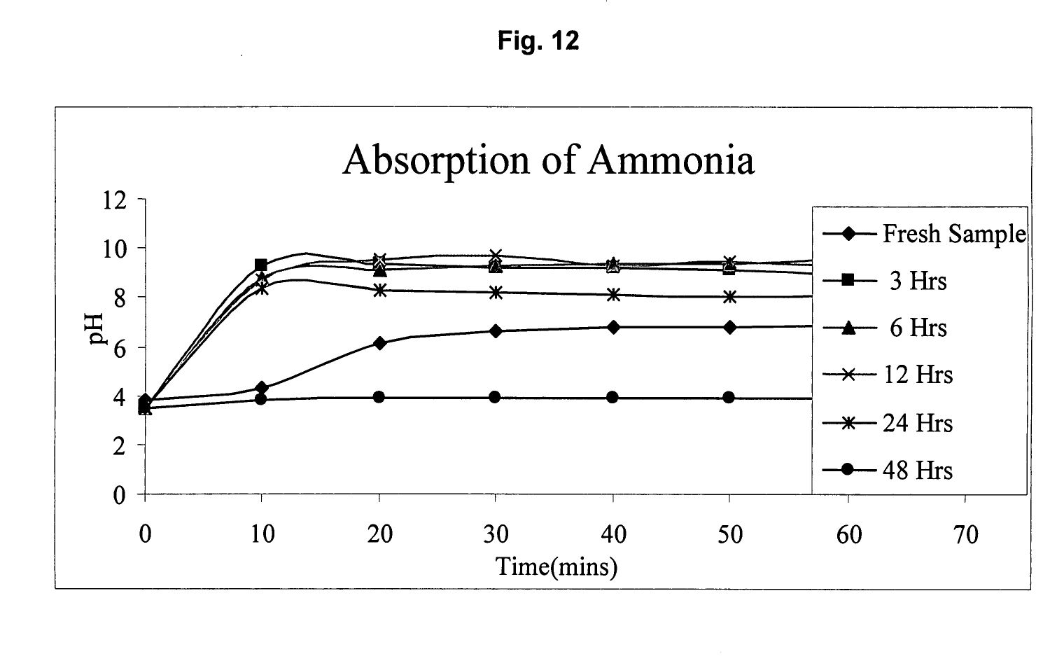

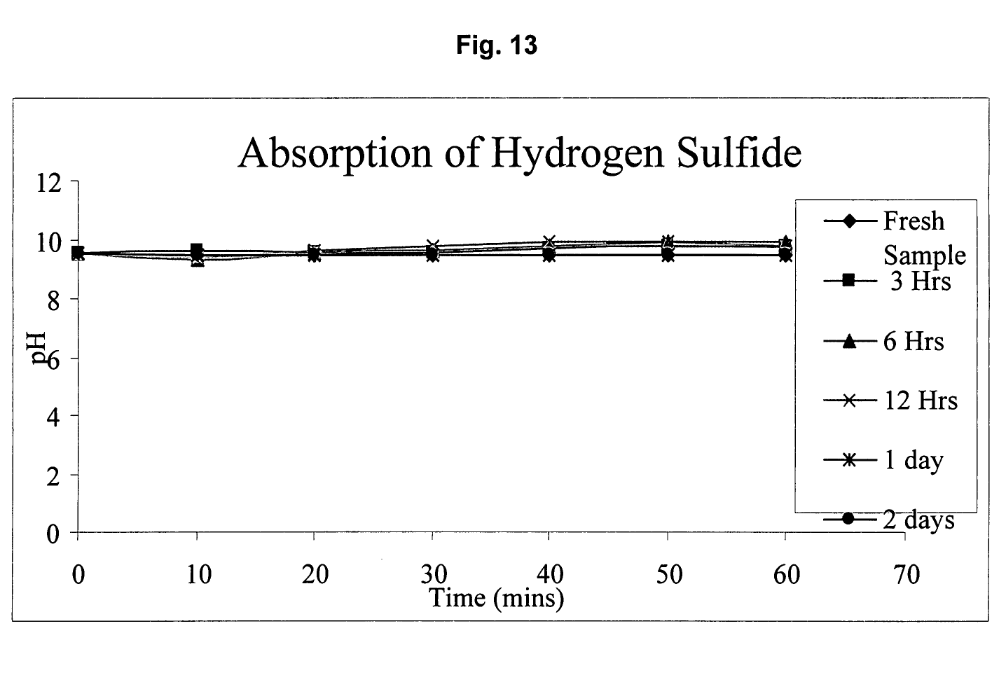

FIG. 9 is a graph reflecting the absorption of hydrogen sulfide from the cow manure treated with Sample No. 30. For comparison purposes, FIG. 10 is a graph reflecting the absorption of ammonia from the cow manure treated with Sample No. 31. FIG. 11 is a graph reflecting the absorption of hydrogen sulfide from the cow manure treated with Sample No. 31. FIG. 12 is a graph reflecting the absorption of ammonia from the cow manure treated with Sample No. 32. FIG. 13 is a graph reflecting the absorption of hydrogen sulfide from the cow manure treated with Sample No. 32.

### Leachable Phosphorous in Manure

A common use of livestock manure is as fertilizer on farms. The important nutrients of the manure are phosphorous and nitrogen, among some other micronutrients. These nutrients are easily leached, however, from the fresh manure during storage or after application. The leaching undermines the effectiveness of the manure as fertilizer and causes heavy pollution problems to natural ecosystems. The phosphorous runoff from the agricultural land contributes to eutrophication of surface waters. In the areas with intensive animal farming, phosphorous loss from manure fields may be elevated due to high concentrations of phosphorous in manure.

Since the 1970's, phosphorus removal from wastewater has been recognized as one of the basic processes necessary to be done at all wastewater treatment plants. Continuous development of knowledge concerning phosphorus occurrence, mechanism of its removal, and evolution of process technologies has led to modern technical solutions which allow efficient removal of this wastewater constituent.

In our study, the leaching of phosphorous was controlled by stabilization of the fresh manure by the addition of the composition according to the present invention. The fresh and stabilized manures were mixed with 30 ml of distilled water and shaken for 1 hour to simulate raining or flashing conditions. Then, the amount of phosphorous leached into the water was tested with the standard total phosphorous methods. The results are shown in Table 1.

TABLE 1
Leaching amount of phosphate from the
fresh and stabilized manure samples

| | Dry | | mg PO₄/g Dry |
|---|---|---|---|
| | Solids | mg PO₄/g | Solids in |
| | Content | Manure | Manure |
| Manure | (%) | (mg/g) | (mg/g) |
| Fresh | 21 | 0.4497 | 2.1414 |
| Stabilized | 79 | 0.0553 | 0.2633 |

Second, the Toxicity Characteristic Leaching Procedure (TCLP; Standard Method) was done to conduct the tests for the manure samples. Extraction fluid of 20 times the weight of the percentage of dry solids in the manure was prepared. 100 g of the fresh and stabilized samples were taken along with extraction fluid and were tumbled for 18 hours at room temperature. The extraction fluid was prepared by adding 5.7 ml of glacial acetic acid to 500 ml of reagent water, adding 64.3 ml of 1 N sodium hydroxide solution, and then diluting it to a volume of 1 liter. The pH of the extraction fluid prepared was 4.91.

After 18 hours extraction, the sample in the bottle was filtered through a new glass fiber filter. The filtrate was again tested with the standard total phosphorous methods. The results are shown in Table 2.

TABLE 2
TCLP test for the amount of phosphate leached
from the fresh and stabilized manure samples

| | | mg PO₄/g Dry |
|---|---|---|
| | mg PO₄/g | Solids in |
| | Manure | Manure |
| Manure | (mg/g) | (mg/g) |
| Fresh | 0.3303 | 1.5728 |
| Stabilized | 0.05199 | 0.2475 |

Table 1 shows that, after stabilization, the dry solid content was increased. This will be helpful for storage, transport, and use of the manure. Furthermore, the leaching amount of phosphorous was largely reduced after stabilization, as shown in Tables 1 and 2. The data of Table 1 show that 2.14 mg of phosphate (PO₄) was leached from 1 g of fresh manure under the simulated conditions. This value decreases to 0.26 mg, by a factor of 8 (or about 88%), after manure stabilization (Table 2). And, 1.57 mg of phosphate (PO₄) was leached per gram of fresh manure and 0.25 mg was leached per gram of fresh manure in stabilized manure in the TCLP test reflected in Table 2. This result means that phosphorous leaching in manure is reduced by 85-90% by using the stabilization methods completed in the laboratory.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

What is claimed:

1. A composition for treating waste material, the composition comprising:
gypsum in a weight ratio of about 15-40%;
lime in a weight ratio of about 9-40%; and
silica or fly ash in a weight ratio of about 15-40%.

2. The composition of claim 1 further comprising water in a weight ratio of about 0-40%.

3. The composition of claim 2 further comprising iron slag in a weight ratio of about 20-25%.

4. The composition of claim 2 further comprising portland cement in a weight ratio of about 30-50%.

5. The composition of claim 2 further comprising iron slag in a weight ratio of about 20-25% and portland cement in a weight ratio of about 30-50%.

6. The composition of claim 1 further comprising iron slag in a weight ratio of about 20-25%.

7. The composition of claim 6 further comprising portland cement in a weight ratio of about 30-50%.

8. The composition of claim 1 further comprising portland cement in a weight ratio of about 30-50%.

9. The composition of claim 1 further comprising fertilizer.

10. A method of stabilizing waste materials comprising the step of treating the waste materials with a composition including gypsum in a weight ratio of about 15-40%; lime in a weight ratio of about 9-40%; and silica or fly ash in a weight ratio of about 15-40%.

11. The method of claim 10 wherein the composition further includes water in a weight ratio of about 0-40%.

12. The method of claim 11 wherein the composition further includes iron slag in a weight ratio of about 20-25%.

13. The method of claim 11 wherein the composition further includes portland cement in a weight ratio of about 30-50%.

14. The method of claim 11 wherein the composition further includes iron slag in a weight ratio of about 20-25% and portland cement in a weight ratio of about 30-50%.

15. The method of claim 10 wherein the composition further includes iron slag in a weight ratio of about 20-25%.

16. The method of claim 15 wherein the composition further includes portland cement in a weight ratio of about 30-50%.

17. The method of claim 10 wherein the composition further includes portland cement in a weight ratio of about 30-50%.

18. The method of claim 10 wherein the composition further includes fertilizer.

19. A method of measuring the amount of ammonia in a waste material, the method comprising:
(a) delivering an inert gas from a source to a closed bottle having a sample of the waste material;
(b) transferring the gas produced in the closed bottle to a closed first reactor vessel having an HCl solution;
(c) measuring with a pH probe the pH of the HCl solution; and
(d) sending a signal indicative of the pH measurement to a computer which can read and report the pH measurement as well as calculate the concentration of ammonia based on that measurement.

20. A method of measuring the amount of hydrogen sulfide in a waste material, the method comprising:
(a) delivering an inert gas from a source to a closed bottle having a sample of the waste material;
(b) transferring the gas produced in the closed bottle to a closed first reactor vessel having an acidic solution;
(c) delivering the gas from the closed first reactor vessel to a second reactor vessel having a basic solution;
(d) measuring with a pH probe the pH of the basic solution; and
(e) sending a signal indicative of the pH measurement to a computer which can read and report the pH measurement as well as calculate the concentration of hydrogen sulfide based on that measurement.
